(19) United States
(12) Patent Application Publication
(10) Pub. No.: US 2014/0365936 A1
(43) Pub. Date: Dec. 11, 2014

(54) APPARATUS AND METHOD FOR DISPLAYING CONTENT IN MOBILE TERMINAL

(71) Applicant: Samsung Electronics Co., Ltd., Gyeonggi-do (KR)

(72) Inventors: Kwang-Tai KIM, Gyeonggi-do (KR); Ji-Hea PARK, Seoul (KR); Young-Eun HAN, Gyeonggi-do (KR)

(21) Appl. No.: 14/296,758

(22) Filed: Jun. 5, 2014

(30) Foreign Application Priority Data
Jun. 7, 2013 (KR) 10-2013-0065414

(51) Int. Cl. G06F 3/0486; G06F 3/0485; G06F 3/0484

(52) U.S. Cl. CPC G06F 3/0486; G06F 3/04845; G06F 3/0485
USPC 715/769; 715/838; 715/784

(57) ABSTRACT

There are provided an apparatus and method for displaying content, e.g., images, in a mobile terminal A plurality of content may be displayed in a plurality of display areas separately. If one of the plurality of content is selected, some areas of the selected content may be sequentially displayed in a display area corresponding to the selected content among the plurality of display areas.

### CLAIM OF PRIORITY

This application claims the benefit under 35 U.S.C. §119(a) of a Korean Patent Application filed in the Korean Intellectual Property Office on Jun. 7, 2013 and assigned Serial No. 10-2013-0065414, the entire disclosure of which is incorporated herein by reference.

### BACKGROUND

1. Technical Field The present disclosure relates generally to a mobile terminal, and more particularly, to an apparatus and method for displaying content in a mobile terminal.

2. Description of the Related Art

Mobile terminals such as smart phones, tablet computers and set-top boxes may provide a variety of useful features to users through various applications. The mobile terminals have been evolving into devices that can provide a variety of features, allowing users to enjoy various types of information. The mobile terminals may provide the feature of displaying images in the form of thumbnail. The term “thumbnail image” as used herein may refer to an image, which is smaller in size than its original image.

After a mobile terminal displays a plurality of thumbnail images, a thumbnail, a part of which is displayed, may be selected from the plurality of displayed thumbnail images. As shown in FIG. 1A, a partial thumbnail image 103 of a plurality of partial thumbnail images 103, that are displayed along rows R and columns C within a grid, may be selected or touched U by a user U on a screen 101. In response to this selection by the user U, a full thumbnail image 109 of the image that was partially displayed within the partial thumbnail image 103 may be displayed within part of the screen 101, for example the image 109 may now occupy two rows R, thereby covering another image 103 that was previously displayed within one of the rows R, as shown in FIG. 1B. Alternatively, as shown in FIG. 1C, the selected image may be displayed as an enlarged image 113, (e.g., original size) on the full screen 101 obscuring the images 103 that were previously displayed in the rows R and columns C of the screen 101.

Since the full thumbnail image 109 or the original image 113 is displayed over or instead of other thumbnail images 103 that were previously shown on the screen 101, the user cannot see the hidden or covered thumbnail images because they have been covered or hidden by the full thumbnail image 109 or the enlarged image 113.

The above information is presented as background information only to assist with an understanding of the present disclosure. No determination has been made, and no assertion is made, as to whether any of the above might be applicable as prior art with regard to the present invention.

### SUMMARY

An aspect of the present disclosure is to address at least the above-mentioned problems and/or disadvantages and to provide at least the advantages described below.

In an embodiment, a content display apparatus, e.g., a mobile terminal, is provided and method for sequentially displaying some areas of a selected thumbnail image without changing the layout of thumbnails displayed on a screen of the content display apparatus such that a user may view those areas of the selected image without obscuring the other displayed thumbnail images of the thumbnail display area.

In another embodiment, there is provided an apparatus for displaying content, e.g., images, in a mobile terminal. The apparatus includes a display for displaying a plurality of content or images in a plurality of display areas separately, and a controller for, sequentially displaying some areas of the selected content in a display area corresponding to the selected content among the plurality of display areas when one of the plurality of images is selected.

In another embodiment, there is provided a method for displaying content in a mobile terminal The method includes displaying a plurality of content or images in a plurality of display areas separately, determining whether one of the plurality of content is selected; and if one of the plurality of content is selected, sequentially displaying some areas of the selected content or image in a display area corresponding to the selected content among the plurality of display areas.

Other aspects, advantages, and salient features of the disclosure will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1A is a front view of a mobile terminal including a screen on which thumbnail images are displayed;

FIG. 1B is a front view of the mobile terminal of FIG. 1A in which a full image of a selected thumbnail image overlies one of a plurality of other thumbnail image of FIG. 1A;

FIG. 1C is a front view of the mobile terminal of FIG. 1A in which a full image of a selected thumbnail image overlies all of the other thumbnail images of FIG. 1A;

FIG. 2 is a flowchart illustrating changes to screens, on which thumbnail images are displayed, in a mobile terminal in response to a user input according to a first exemplary embodiment of the present disclosure;

FIG. 3 is a flowchart illustrating changes to screens, on which thumbnail images are displayed, in a mobile terminal in response to a user input according to a second exemplary embodiment of the present disclosure;

FIG. 4 is a block diagram of a mobile terminal according to an exemplary embodiment of the present disclosure;

FIG. 5 is a flowchart of displaying thumbnail images in a mobile terminal according to the first exemplary embodiment of the present disclosure; and

FIG. 6 is a flowchart of displaying thumbnail images in a mobile terminal according to the second exemplary embodiment of the present disclosure.

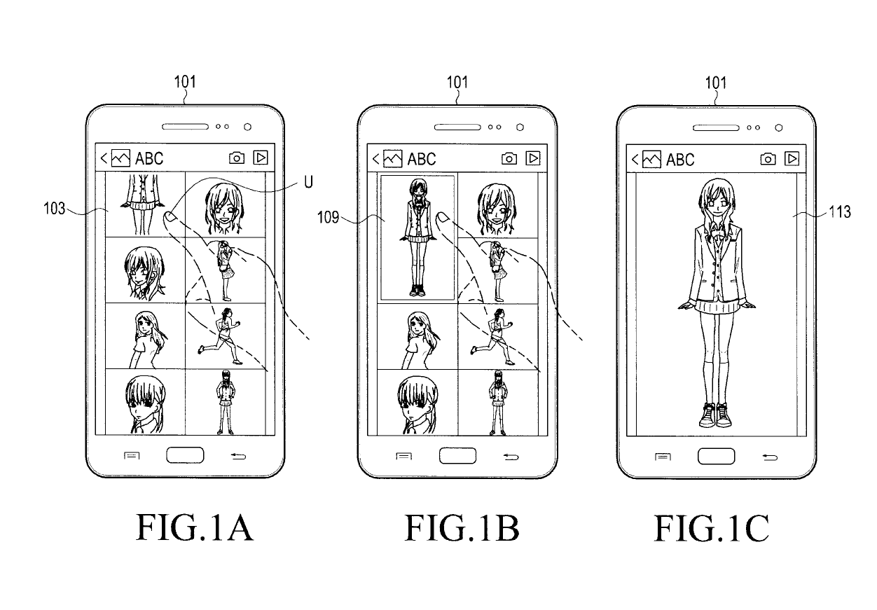

Throughout the drawings, like reference numerals will be understood to refer to like parts, components, and structures.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skilled in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings or any extrinsic dictionary definition, but are merely used by the inventor to enable a clear and consistent understanding of the invention. Accordingly, it should be apparent to those skilled in the art that the following description of exemplary embodiments of the present disclosure is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A mobile terminal, to which exemplary embodiments of the present invention are applicable, and which is an easy-to-carry mobile electronic device, may include a video phone, a cellular phone, a smart phone, an International Mobile Telecommunication 2000 (IMT-2000) terminal, a Wideband Code Division Multiple Access (WCDMA) terminal, a Universal Mobile Telecommunication Service (UMTS) terminal, a Personal Digital Assistant (PDA), a Portable Multimedia Player (PMP), a Digital Multimedia Broadcasting (DMB) terminal, an Electronic book (E-book) reader, a portable computer (for example, a laptop computer, a tablet computer, and the like), or a digital camera.

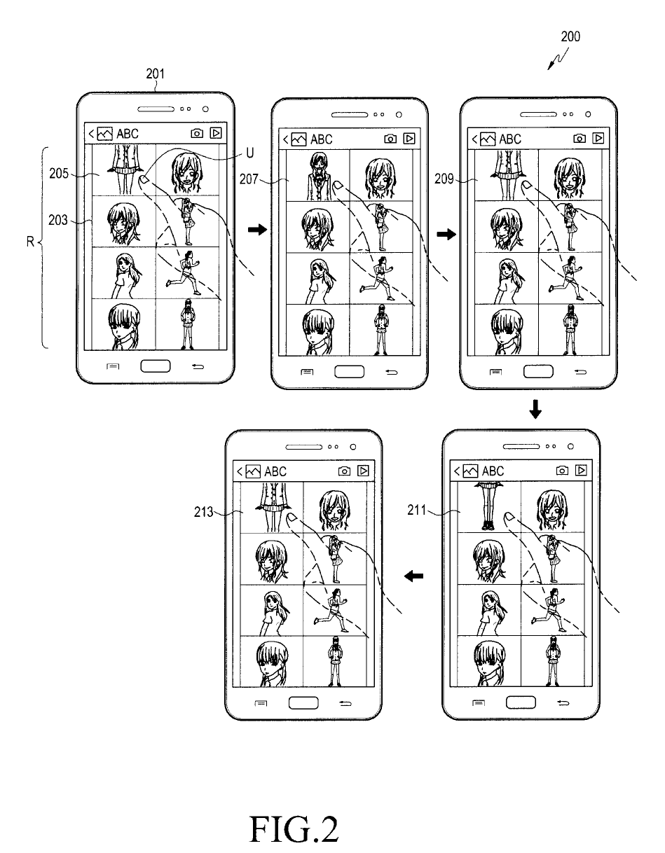

FIG. 2 is a flowchart illustrating changes to screens, on which thumbnail images are displayed, in a mobile terminal in response to a user input according to a first exemplary embodiment of the present disclosure.

Referring to FIG. 2, a mobile terminal 200 may display a plurality of thumbnail images 203 as shown in a screen 201. The mobile terminal 200 may display the thumbnail images 203 in their associated thumbnail display areas having a predetermined size, e.g., within a given row R and column C. If at least one of the plurality of thumbnail images 203 exceeds in size its associated thumbnail display area, so its full thumbnail image may not be displayed in the thumbnail display area, the mobile terminal may display the thumbnail image on the basis of a part of the thumbnail image (for example, the central part of the thumbnail image, or the face part (if any) of the thumbnail image).

If one of the thumbnail images 203, which exceeds its associated thumbnail display area in size, is selected from the plurality of thumbnail images 203 by the user U, the mobile terminal 200 may display the selected thumbnail image by sliding the selected thumbnail image in the thumbnail display area. The term “sliding” as used herein may refer to an operation of sequentially displaying some areas of the thumbnail image so that the user may recognize the entire area of the thumbnail image.

For example, if a thumbnail image 205, which is displayed on the basis of its central part as it exceeds its associated thumbnail display area in size, is touched by the user U, the mobile terminal 200 may sequentially display different areas 207, 209, 211 and 213 (e.g., upper, middle, and/or lower portions) of the thumbnail image 205 by sliding the thumbnail image 205 according to a predetermined direction (or in a predetermined direction). In other words, the mobile terminal 200 may display the selected thumbnail image 205 by sequentially scrolling the selected thumbnail image 205 in the thumbnail display area.

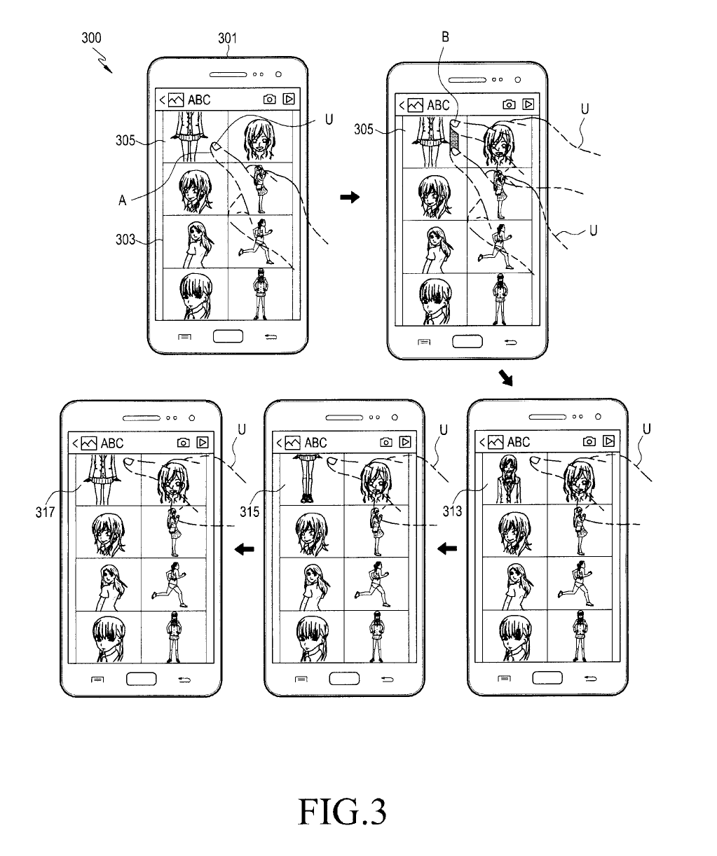

FIG. 3 is a flowchart illustrating changes to screens, on which thumbnail images are displayed, in a mobile terminal in response to a user input according to a second exemplary embodiment of the present disclosure.

Referring to FIG. 3, a mobile terminal 300 may display a plurality of thumbnail images 303 as shown in a screen 301. The mobile terminal 300 may display the thumbnail images 303 in their associated thumbnail display areas having a predetermined size. If at least one of the plurality of thumbnail images303 exceeds in size its associated thumbnail display area such that its full image may not be displayed in the thumbnail display area, the mobile terminal 300 may display the thumbnail image on the basis of a part of the thumbnail image (for example, the central part of the thumbnail image, or the face part (if any) of the thumbnail image).

If a thumbnail image, which exceeds its thumbnail display area in size, is selected from the plurality of thumbnail images by the user U, the mobile terminal 300 may get a sliding direction entered by the user U, e.g., a sliding movement in a direction from point or location A to point or location B, as shown in the successive illustrations of the screens 301. For example, if a thumbnail image 305, which is displayed showing its central part as it exceeds its associated thumbnail display area in size, is touched by the user U, the mobile terminal 300 may determine that the thumbnail image 305 is selected. If the thumbnail image 305 is dragged in an upper direction after being touched at location A and being dragged toward location B, the mobile terminal 300 may determine that the entered sliding direction is the upper direction.

The mobile terminal 300 may display the selected thumbnail image 305 by sliding the selected thumbnail image 305 in the entered sliding direction (e.g., in a direction from location A to location B). The term “sliding” as used herein may refer to an operation of sequentially displaying some areas of the thumbnail image so that the user may recognize or view the entire area of the thumbnail image. For example, if the sliding direction is the upper direction toward location B, the mobile terminal may sequentially display different some areas 313, 315 and 317 (e.g., upper, lower, and center areas) of the thumbnail image by sliding the thumbnail image in the upper direction from location A to location B. In other words, the mobile terminal 200 may display the selected thumbnail image 305 by sequentially scrolling the selected thumbnail image in the thumbnail display area, in the upper direction from location A to location B. When a user selects a thumbnail, the thumbnail is scrolled and displayed, and when a sliding direction is entered while scrolling the thumbnail, the scroll direction to the thumbnail may be changed according to the sliding direction.

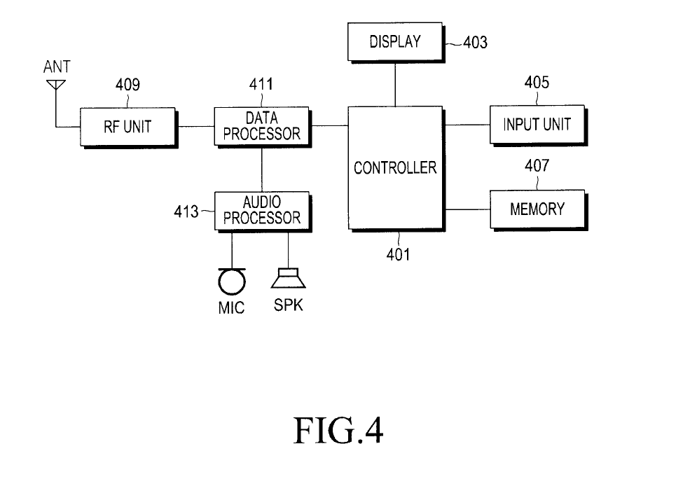

FIG. 4 is a block diagram of a mobile terminal according to an exemplary embodiment of the present disclosure.

Referring to FIG. 4, a mobile terminal may include a controller 401, a display 403, an input unit 405, a memory 407, a Radio Frequency (RF) unit 409, a data processor 411, and an audio processor 413.

The RF unit 409 is responsible for radio communication of the mobile terminal More specifically, the RF unit 409 may include a radio transmitter for up-converting a frequency of a transmission signal and amplifying the up-converted transmission signal, and a radio receiver for low-noise-amplifying a received signal and down-converting a frequency of the amplified received signal. The data processor 411 may include a transmitter for coding and modulating a transmission signal, and a receiver for demodulating and decoding a received signal. The data processor 411 may include a modulator/demodulator (modem) and a coder/decoder (codec), and the codec may include a data codec for processing packet data and the like, and an audio codec for processing audio signals such as voice.

The audio processor 413 may play a received audio signal output from the data processor 411 using a speaker SPK, or transfer a transmission audio signal picked up by a microphone MIC to the data processor 411. The input unit 405 may include numeric/character keys for entering numeric/character information, and function keys for setting various functions. The display 403 may display, on its screen, image signals output from the data processor 411 and requested data output from the controller 401.

If the display 403 is implemented as a touch screen, for example, as a capacitive touch screen or a resistive touch screen, the input unit 405 may include only the minimum number of predetermined keys, and the display 403 may replace some of the key input function of the input unit 405. The memory 407 may include a program memory and a data memory. The program memory may store booting and Operating System (OS) for controlling the general operation of the mobile terminal, and the data memory may store various data generated during an operation of the mobile terminal.

The controller 401 may control the overall operation of the mobile terminal In particular, the controller 401 may slide a thumbnail image selected from the plurality of thumbnail images by the user, in its associated thumbnail display area so that the user may recognize the entire area of the thumbnail image.

More specifically, in the first exemplary embodiment, the controller 401 may display a plurality of thumbnail images. If an application is executed by the user U or certain conditions are met during the execution of the application, the controller 401 may display the plurality of thumbnail images. The application may be a Gallery application for displaying at least one image pre-stored in the memory 407, as a thumbnail image, or a Web Surfing application for accessing a web site selected by the user, receiving at least one image from the accessed web site, and displaying the received image as a thumbnail image.

The controller 401 may display a plurality of thumbnail images in their associated thumbnail display areas having a predetermined size. If at least one of the plurality of thumbnail images exceeds in size its associated thumbnail display area, so its full thumbnail image may not be displayed in the thumbnail display area, the controller 401 may display the thumbnail image on the basis of a part of the thumbnail image (for example, the central part of the thumbnail image, or the face part (if any) of the thumbnail image).

The controller 401 may determine whether a thumbnail image, which exceeds its associated thumbnail display area in size, has been selected from the plurality of displayed thumbnail images by the user. If one of the plurality of displayed thumbnail images undergoes touching, gaze recognition or hovering, the controller 401 may determine that one of the plurality of displayed thumbnail images is selected.

If it is determined that a thumbnail image, which exceeds its thumbnail display area in size, has been selected by the user, the controller 401 may display the selected thumbnail image by sliding the selected thumbnail image in its thumbnail display area without changing the layout of the thumbnail display areas. In other words, the controller 401 may display the selected thumbnail image by sequentially scrolling the selected thumbnail image in its the thumbnail display area.

The term “sliding” as used herein may refer to an operation of sequentially displaying some areas of the thumbnail image so that the user may recognize the entire area of the thumbnail image. The term “predetermined direction” may be construed to include a first direction from the top to the bottom of the thumbnail image, or a second direction from the left to the right of the thumbnail image.

For example, with reference to FIGS. 2 and 4, if a thumbnail image 205, which is displayed on the basis of its central part as it exceeds its associated thumbnail display area in size, is touched by the user U, the controller 401 may sequentially display different some areas 207, 209, 211 and 213 of the thumbnail image 205 by sliding the thumbnail image 205 according to the first direction.

The controller 401 may determine whether the selection of the thumbnail image has been released by the user. If it is determined that the selection of the thumbnail image is released, the controller 401 may exit the operation of sliding the thumbnail image, and display the thumbnail image on the basis of a part of the thumbnail image. For example, if the touch U is released, the controller 401 may display the thumbnail image 205 on the basis of the central part of the thumbnail image 205 (e.g., some area 213 of the thumbnail image 205), determining that the selection of the thumbnail image 205 has been released.

On the other hand, if the selection of the thumbnail image is not released, the controller 401 may continuously perform the operation of sliding the thumbnail image.

In the second exemplary embodiment, the controller 401 may display a plurality of thumbnail images. The controller 401 may display the plurality of thumbnail images in their associated thumbnail display areas having a predetermined size. If at least one of the plurality of thumbnail images exceeds in size its associated thumbnail display area, so its full thumbnail image may not be displayed in the thumbnail display area, the controller 401 may display the thumbnail image on the basis of a part of the thumbnail image (for example, the central part of the thumbnail image, or the face part (if any) of the thumbnail image).

The controller 401 may determine whether a thumbnail image, which exceeds its associated thumbnail display area in size, is selected from the plurality of displayed thumbnail images by the user. If one of the plurality of displayed thumbnail images undergoes touching, gaze recognition or hovering, the controller 401 may determine that one of the plurality of displayed thumbnail images is selected.

If it is determined that a thumbnail image, which exceeds its thumbnail display area in size, is selected by the user, the controller 401 may determine whether a sliding direction is entered by the user. The term “sliding” as used herein may refer to an operation of sequentially displaying some areas of the thumbnail image in a predetermined direction so that the user may recognize the entire area of the thumbnail image.

For example, referring to FIGS. 3 and 4, if a thumbnail image 305, which is displayed on the basis of its central part as it exceeds its associated thumbnail display area in size, is touched by the user U, the controller 401 may determine that the thumbnail image 305 is selected. If the thumbnail image 305 is dragged in an upper direction, i.e., from location A to location B, after its touch, the controller 401 may determine that the entered sliding direction is the upper direction.

If it is determined that the sliding direction is entered, the controller 401 may display the selected thumbnail image 305 by sliding the selected thumbnail image 305 in the entered sliding direction without changing the layout of thumbnail display areas. The term “sliding” as used herein may refer to an operation of sequentially displaying some areas of the thumbnail image so that the user may recognize the entire area of the thumbnail image. For example, if the sliding direction is the upper direction, i.e., from location A to location B, the controller 401 may sequentially display different some areas 313, 315 and 317 (e.g., upper, lower, and center areas) of the thumbnail image by sliding the thumbnail image in the upper direction 309.

The controller 401 may determine whether the selection of the thumbnail image is released by the user. If it is determined that the selection of the thumbnail image is released, the controller 401 may exit the operation of sliding the thumbnail image, and display the thumbnail image on the basis of a part of the thumbnail image. For example, if the thumbnail image is no longer touched, the controller 401 may display the thumbnail image 305 with area 317, corresponding to the central portion of thumbnail image 303, being displayed. On the other hand, if the selection of the thumbnail image is not released, the controller 401 may continuously perform the operation of sliding the thumbnail image.

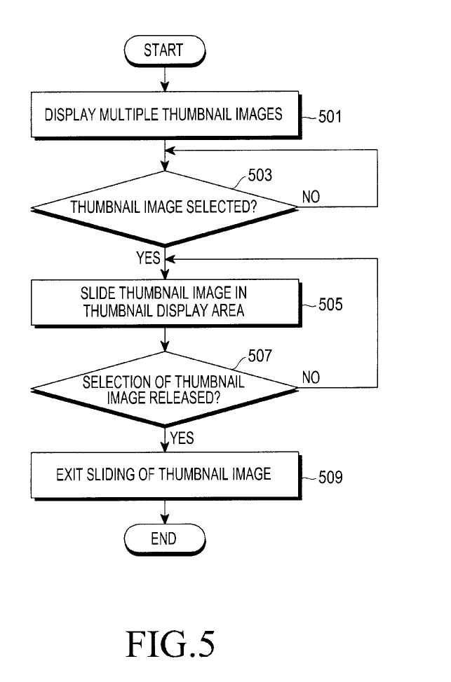

FIG. 5 is a flowchart of displaying thumbnail images in a mobile terminal according to the first exemplary embodiment of the present disclosure.

Referring to FIG. 5, the controller 401 may display a plurality of thumbnail images in step 501. If an application is executed by the user or certain conditions are met during the execution of the application, the controller 401 may display the plurality of thumbnail images. The application may be a Gallery (e.g., a gallery of photographs or images) application for displaying at least one image pre-stored in the memory 407, as a thumbnail image, or a Web Surfing application for accessing a web site selected by the user, receiving at least one image from the accessed website, and displaying the received image as a thumbnail image.

The controller 401 may display a plurality of thumbnail images in their associated thumbnail display areas having a predetermined size. If at least one of the plurality of thumbnail images exceeds in size its associated thumbnail display area, so its full thumbnail image may not be displayed in the thumbnail display area, the controller 401 may display the thumbnail image on the basis of a part of the thumbnail image (for example, the central part of the thumbnail image, or the face part (if any) of the thumbnail image).

The controller 401 may determine in step 503 whether a thumbnail image, which exceeds its associated thumbnail display area in size, is selected from the plurality of displayed thumbnail images by the user. If one of the plurality of displayed thumbnail images undergoes touching, gaze recognition or hovering, the controller 401 may determine that one of the plurality of displayed thumbnail images is selected. If it is determined that a thumbnail image, which exceeds its thumbnail display area in size, is selected by the user, the controller 401 may proceed to step 505. Otherwise, the controller 401 may repeat step 503.

In step 505, the controller 401 may display the selected thumbnail image by sliding the selected thumbnail image in its thumbnail display area without changing the layout of thumbnail display areas. The term ‘sliding’ as used herein may refer to an operation of sequentially displaying some areas of the thumbnail image so that the user may recognize the entire area of the thumbnail image. The term “predetermined direction” may be construed to include a first direction from the top to the bottom of the thumbnail image, or a second direction from the left to the right of the thumbnail image.

For example, referring to FIG. 2, if a thumbnail image 205, which is displayed on the basis of its central part as it exceeds its associated thumbnail display area in size, is touched by the user U, the controller 401 may sequentially display different areas or portions 207, 209, 211 and 213 (e.g., from the upper to the lower areas) of the thumbnail image 205 by sliding the thumbnail image 205 according to the first direction.

In step 507, the controller 401 may determine whether the selection of the thumbnail image is released by the user. If it is determined that the selection of the thumbnail image is released, the controller 401 may proceed to step 509. Otherwise, the controller 401 may return to step 505.

In step 509, the terminal 401 may exit the operation of sliding the thumbnail image, and display the thumbnail image on the basis of a part of the thumbnail image. For example, if the touch is released, the controller 401 may display the thumbnail image 205 on the basis of the central part of the thumbnail image 205, determining that the selection of the thumbnail image is released.

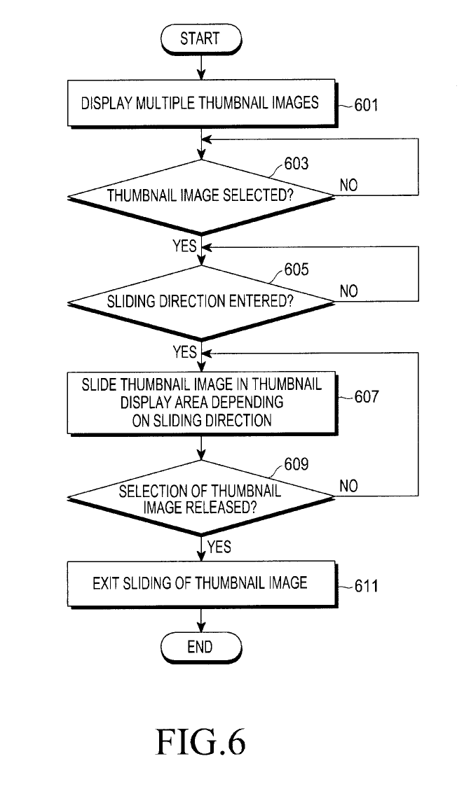

FIG. 6 is a flowchart of displaying thumbnail images in a mobile terminal according to the second exemplary embodiment of the present disclosure.

Referring to FIG. 6, the controller 401 may display a plurality of thumbnail images in step 601. The controller 401 may display the plurality of thumbnail images in their associated thumbnail display areas having a predetermined size. If at least one of the plurality of thumbnail images exceeds in size its associated thumbnail display area, so its full thumbnail image may not be displayed in the thumbnail display area, the controller 401 may display the thumbnail image on the basis of a part of the thumbnail image (for example, the central part of the thumbnail image, or the face part (if any) of the thumbnail image).

The controller 401 may determine in step 603 whether a thumbnail image, which exceeds its associated thumbnail display area in size, is selected from the plurality of displayed thumbnail images by the user. If one of the plurality of displayed thumbnail images undergoes touching, gaze recognition or hovering, the controller 401 may determine that one of the plurality of displayed thumbnail images is selected. For example, if a thumbnail image 305, which is displayed on the basis of its central part as it exceeds its associated thumbnail display area in size, is touched by the user, the controller 401 may determine that the thumbnail image 305 is selected.

If it is determined that the thumbnail image, which exceeds its associated thumbnail display area in size, is selected, the controller 401 may proceed to step 605. Otherwise, the controller 401 may repeat step 603.

In step 605, the controller 401 may determine whether a sliding direction is entered by the user. The term “sliding” as used herein may refer to an operation of sequentially displaying some areas of the thumbnail image so that the user may recognize the entire area of the thumbnail image. For example, referring to FIG. 3, if the thumbnail image 305 is dragged in an upper direction, i.e., from location A to location B, after its touch, the controller 401 may determine that the entered sliding direction is the upper direction.

If it is determined that the sliding direction is entered, the controller 401 may proceed to step 607. Otherwise, the controller may repeat step 605.

In step 607, the controller 401 may display the selected thumbnail image 305 by sliding the selected thumbnail image 305 in the entered sliding direction without changing the layout of thumbnail display areas. The term ‘sliding’ as used herein may refer to an operation of sequentially displaying some areas of the thumbnail image so that the user may recognize the entire area of the thumbnail image.

For example, if the sliding direction is the upper direction 309, the controller 401 may sequentially display different areas 313, 315 and 317 of the thumbnail image by sliding the thumbnail image in the upper direction, i.e., from location A to location B.

The controller 401 may determine in step 609 whether the selection of the thumbnail image is released by the user. If it is determined that the selection of the thumbnail image is released, the controller 401 may proceed to step 611. Otherwise, the controller 401 may return to step 607.

In step 611, the controller 401 may exit the operation of sliding the thumbnail image, and display the thumbnail image on the basis of a part of the thumbnail image. For example, if the touch is released, the controller 401 may display the thumbnail image 305 on the basis of the central part of the thumbnail image 305 (e.g., some area 317 of the thumbnail image 305), determining that the selection of the thumbnail image is released.

In this way, according to exemplary embodiments of the present invention, the mobile terminal may sequentially display some areas of the selected thumbnail image without changing the layout of thumbnail display areas, allowing the user to fully view the content.

The method of displaying content according to the present invention may be implemented as computer-readable code in a computer-readable recording medium. The computer-readable recording medium may include any kind of recording device storing computer-readable data. The typical example of the recording medium may include Read Only Memory (ROM), Random Access Memory (RAM), optical disk, magnetic tape, floppy disk, hard disk, and non-volatile memory, and may also include a recording medium implemented in the form of carrier wave (for example, transmission over the Internet). The computer-readable recording medium may be distributed over the networked computer systems, and the computer-readable code may be stored and executed in a distributed manner.

As is apparent from the foregoing description, according to exemplary embodiments of the present invention, the mobile terminal may sequentially display some areas of a selected thumbnail image without changing the layout of thumbnail display areas, allowing the user to fully view the content.

While the invention has been shown and described with reference to certain exemplary embodiments thereof, it will be understood by those skilled in the art that various changes in form and details may be made therein without departing from the spirit and scope of the invention as defined by the appended claims and their equivalents.

For example, although the thumbnail image is assumed to be selected by detecting the user's touch in the present invention, the thumbnail image may be selected by recognizing the user's gaze. In addition, although the sliding direction is assumed to be entered by detecting the user's drag in the present invention, the sliding direction may be entered by recognizing the user's gaze shift.

As another example, although the invention has been described with reference to the apparatus and method for displaying content using thumbnail images, the present invention is not limited thereto. In particular, the content may include not only the thumbnail images, but also images, E-mail list, text message list, calendar's schedule list, and the like. If an E-mail list is displayed, and then, a specific E-mail in the E-mail list is selected by the user, the mobile terminal may display the content of the selected specific E-mail in a sliding way without changing the layout of the display areas. If a text message list is displayed, and then, a specific text message in the text message list is selected by the user, the mobile terminal may display the content of the selected specific text message in a sliding way without changing the layout of the display areas.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

It is to be understood that the above-described embodiments are merely illustrative of the principles and applications of the present disclosure. It is therefore to be understood that numerous modifications may be made to the illustrative embodiments and that other arrangements may be devised without departing from the scope and spirit of the present invention as defined by the appended claims. It will be appreciated that the various dependent claims and features set forth therein can be combined in different ways than presented in the initial claims. It will be appreciated that any individual features described in connection with any embodiment may be shared with others of the described embodiments. The alternative embodiments presented hereinabove are not mutually exclusive, but may be implemented in various combinations of the features discussed above and can be utilized without departing from the scope and spirit of the present disclosure, the foregoing description of the embodiments should be taken by way of illustration rather than by way of limitation.

What is claimed is:

1. An apparatus for displaying content in a mobile terminal, comprising:
a display for displaying a plurality of content in a plurality of display 5 areas separately; and
a controller for sequentially scrolling and displaying at least one of the plurality of content, when the at least one of the plurality of content is selected, in a display area corresponding to the selected content among the plurality of display areas.

2. The apparatus of claim 1, wherein at least a portion of the selected content is displayed in the display area among the plurality of display areas.

3. The apparatus of claim 1, wherein if one of plurality of images undergoes touching, gaze recognition or hovering, the controller determines that one of the plurality of images is selected.

4. The apparatus of claim 1, wherein the controller sequentially scrolls and displays the selected content in a predetermined direction.

5. The apparatus of claim 4, wherein the predetermined direction includes at least one of a direction from a first point to a second point on the selected content, and a direction from a third point to a fourth point of the selected content.

6. The apparatus of claim 1, wherein if a sliding direction is entered, the controller sequentially scrolls and displays the selected content in the entered sliding direction.

7. The apparatus of claim 6, wherein if the selected content under goes drag or gaze shift, the controller determines the sliding direction as a direction of the drag or a direction of the gaze shift.

8. A method for displaying content in a mobile terminal, comprising:
displaying a plurality of content in a plurality of display areas separately;
determining whether one of the plurality of content is selected; and
in response to a selection of one of the plurality of content, sequentially scrolling and displaying the selected content in a display area corresponding to the selected content among the plurality of display areas.

9. The method of claim 8, wherein at least a portion of the selected content is displayed in the display area among the plurality of display areas.

10. The method of claim 8, wherein the determining comprises:
determining that one of the plurality of content is selected when one of the plurality of images undergoes touching, gaze recognition or hovering.

11. The method of claim 8, wherein the scrolling and displaying includes sequentially scrolling and displaying the selected content in a predetermined direction.

12. The method of claim 11, wherein the predetermined direction includes at least one of a direction from a first point to a second point on the selected content, and a direction from a third point to a fourth point of the selected content.

13. The method of claim 8, wherein the scrolling and displaying comprises:
receiving an entered sliding direction; and
sequentially scrolling and displaying the selected content in the entered sliding direction.

14. The method of claim 13, wherein the receiving comprises:
determining the sliding direction as a direction of a drag or a direction of the gaze shift when the selected content undergoes drag or gaze shift.
